(19) United States
(12) Patent Application Publication
(10) Pub. No.: US 2006/0262760 A1
(43) Pub. Date: Nov. 23, 2006

(54) DMB/mobile communication network linkage platform for interactive service, DMB/mobile communication network integrated receiving terminal using the same and method thereof

(76) Inventors: Byung-Jun Bae, Daejon (KR); Woo-Suk Kim, Daejon (KR); Gwang-Soon Lee, Daejon (KR); Young-Kwon Hahm, Daejon (KR); Soo-In Lee, Daejon (KR)

Correspondence Address: LADAS & PARRY LLP, 224 SOUTH MICHIGAN AVENUE, SUITE 1600, CHICAGO, IL, 60604, US

(21) Appl. No.: 11/282,540

(22) Filed: Nov. 18, 2005

(30) Foreign Application Priority Data
May 19, 2005 (KR) 10-2005-0042200

(51) Int. Cl. H04Q 7/24

(52) U.S. Cl. 370/338; 370/395.52

(57) ABSTRACT

A DMB/mobile communication network linkage platform for interactive service, a DMB/mobile communication network integrated receiving terminal using the same and a method thereof are disclosed. The DMB/mobile communication network linkage platform includes: a DMB basic software module for providing DMB basic functions corresponding to a handset basic software of the wireless internet standard platform; a DMB HAL engine as a lower abstract layer for providing a function of controlling DMB and a function for interactive communication; a DMB runtime engine for providing an environment for DMB APIs; and a DMB API module for providing DMB basic APIs corresponding to basic APIs of the wireless Internet standard platform.

### FIELD OF THE INVENTION

The present invention relates to a DMB/mobile communication network linkage platform for interactive service, a DMB/mobile communication network integrated receiving terminal using the same and a method thereof; more particular, to a DMB/mobile communication network linkage platform for interactive data broadcasting service through a mobile communication network by expanding a wireless Internet standard platform, i.e., wireless Internal platform for interoperability (WIPI), to include functions related to terrestrial digital multimedia broadcasting (DMB), a DMB/mobile communication network integrated receiving terminal using the same and a method thereof.

### DESCRIPTION OF RELATED ART

A terrestrial digital multimedia broadcasting (DMB) provides CD-level high-quality audio broadcasting service as well as video and data broadcasting services. The terrestrial DMB also provide superior receiving quality at both of a fixed location and a moving object. It is also possible to provide data broadcasting service dependently or independently to video broadcasting service. That is, a multimedia broadcasting service including moving picture is provided with supplementary data broadcasting service through the terrestrial DMB.

However, quantity of data broadcasting service is limited since a channel of the terrestrial DMB is very narrow. Accordingly, it is impossible to provide data broadcasting service customized to each of users for all of users, and it is not preferable to transmit detailed information through the data broadcasting service to all of users because each of users has different preferences.

Therefore, the terrestrial DMB provides data broadcasting service simple and commonly suitable to all of users. If each of users wants have the detailed information, it is preferable to receive such detailed information through a mobile communication network.

Meanwhile, most of terrestrial DMB terminals are developed as a wireless communication terminal having a function for receiving the terrestrial DMB services. Herein, the wireless communication terminal is a terminal capable of receiving and transmitting voice and multimedia data through a wireless communication network, and the wireless communication terminal may be a handheld phone, a mobile phone, a personal digital assistant (PDA) and a wireless communication terminal for IMT-2000. And, all of domestic wireless communication terminal using a CDMA mobile communication network employs a wireless Internet platform for interoperability (WIPI).

Therefore, there is a great demand of a wireless communication terminal providing an interactive service through a mobile communication network as well as receiving the terrestrial DMB video broadcasting service and data broadcasting service based on the WIPI.

### SUMMARY OF THE INVENTION

It is, therefore, an object of the present invention to provide a DMB/mobile communication network linkage platform for an interactive data broadcasting service through a mobile communication network by expanding a wireless Internet standard platform, i.e., wireless Internal platform for interoperability (WIPI), to include functions related to terrestrial digital multimedia broadcasting (DMB), a DMB/mobile communication network integrated receiving terminal using the same and a method thereof.

In accordance with an aspect of the present invention, there is provided a digital multimedia broadcasting (DMB)/mobile communication network linkage platform having a handset basic software module, a handset adaptation layer (HAL) module, a runtime engine and a basic application program interface (API) module based on a wireless Internet standard platform for interactive service, the DMB/mobile communication linkage platform including: a DMB basic software module for providing DMB basic functions corresponding to a handset basic software of the wireless internet standard platform; a DMB HAL engine as a lower abstract layer for providing a function of controlling DMB and a function for interactive communication; a DMB runtime engine for providing an environment for DMB APIs; and a DMB API module for providing DMB basic APIs corresponding to basic APIs of the wireless Internet standard platform.

In accordance with another aspect of the present invention, there is provided a digital multimedia broadcasting (DMB)/mobile communication network integrated receiving terminal for interactive service, including: a DMB receiving unit for receiving broadcasting stream transmitted through a broadcasting network; a DMB processing unit for determining a type of the broadcasting stream, decoding an audio/video stream and transferring the decoded audio/video stream, reporting completion of data transmission after storing data broadcasting stream, or reporting completion of data transmission after storing interactive data received as a response of interactive data request to a return server; a mobile communication network connecting unit for connecting the return server through a mobile communication network; a DMB/mobile communication network linkage platform for generating an event when the completion of data transmission is received from the DMB processing unit, and ordering the DMB processing unit to request the interactive data to a return server according to a user's request of the interactive data transferred from the integrated browsing unit; and an integrated browsing unit for receiving the decoded audio/video stream from the DMB processing unit, processing data file stored in the DMB processing unit and outputting the processed data file according to receiving of the generated event, or processing and outputting the decoded audio/video stream transferred from the DMB processing unit, and transferring the user's request of the interactive data to the DMB/mobile communication network platform.

In accordance with further another aspect of the present invention, there is provided a method of receiving integrated data for interactive service in a digital multimedia broadcasting (DMB)/mobile communication network integrated receiving terminal employing a DMB/mobile communication network linkage platform expanded based on a wireless Internet standard platform, the method including the steps of: receiving broadcasting stream transmitted through a broadcasting network and determining a type of the received broadcasting stream; transferring the broadcasting stream to an integrated browser when the determined type of the broadcasting stream is an audio/video stream; storing the broadcasting steam when the determined type of the broadcasting stream is a data broadcasting stream, and reporting a first data transmitting completion to the DMB/mobile communication network linkage platform; generating an event according to the reporting of the first data transmitting completion from the DMB/mobile communication network linkage platform and noticing the creation of event to the integrated browser; and at the integrated browser, processing and outputting the data or the decided audio/video stream by recognizing the data transmitting completion by the event.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating a WIPI in accordance with the related art;

FIG. 2 is a diagram illustrating a DMB/mobile communication network linkage platform for interactive service in accordance with a preferred embodiment of the present invention;

FIG. 3 is a diagram of a DMB/mobile communication network integrated receiving terminal employing a DMB/mobile communication network linkage platform for interactive service in accordance with a preferred embodiment of the present invention;

FIG. 4 is a diagram for describing a method of receiving and processing an A/V stream of a video broadcasting transmitted through a terrestrial DMB network in accordance with a preferred embodiment of the present invention;

FIG. 5 is a diagram for describing a method of receiving and processing a data broadcasting stream transmitted through a terrestrial DMB network in accordance with a preferred embodiment of the present invention;

FIG. 6 is a diagram showing a method of transmitting a request of transmitting interactive data from a DMB/mobile communication network integrated receiving terminal to a return server in accordance with a preferred embodiment of the present invention;

FIG. 7 is a diagram showing a method of receiving and processing interactive data transmitted from a return server to a DMB/mobile communication network integrated receiving terminal through a mobile communication network in accordance with a preferred embodiment of the present invention; and

FIG. 8 is a diagram showing a method of transferring data when data broadcasting service is changed by an interactive service through a terrestrial DMB network in accordance with a preferred embodiment of the present invention.

### DETAILED DESCRIPTION OF THE INVENTION

Hereinafter, a DMB/mobile communication network linkage platform for interactive service, a DMB/mobile communication network integrated receiving terminal and a method thereof will be described in more detail with reference to the accompanying drawings.

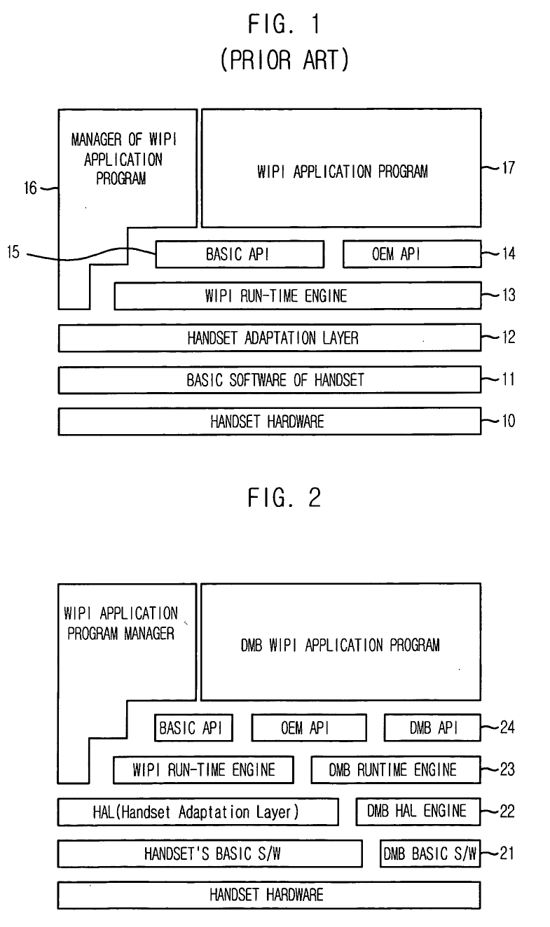

FIG. 1 is a block diagram illustrating a WIPI in accordance with the related art.

Referring to FIG. 1, the wireless Internet platform for interoperability (WIPI) includes a handset hardware 10 for handling necessary functional parts of a terminal which refers to the handset in hardware manner and a handset basic software (S/W) 11 which is an operating system (OS) to drive the handset in software manner. The handset basic S/W 11 provides basic functions such as call processing, user-interface processing, data transmitting and receiving, task management, and resource management. Substantially, the WIPI is embodied on the handset basic S/W. A handset adaptation layer (HAL) 12 is on the handset basic S/W 11. The HAL 12 is an abstraction layer of the handset to provide interoperability of hardware. The HAL 12 provides various functions of the handset basic S/W 11 to a WIPI application programming interface (API).

The functions provided from the HAL 12 are 1) basic functions related to transferring of events or starting of platform, 2) API related to a system, 3) API related to Call, 4) API related to a handset device, 5) API related to a network, 6) API related to serial communication, 7) API related to a short message service (SMS), 8) API related to sound, 9) API related to time/timer, 10) API related to a file system, 11) API related to a vocoder, 12) API related to an input unit, 13) API related font, and 14) API related to virtual keys.

A basic API 15 must be provided to all of terminals employing the WIPI. Two types of API sets are defined in the basic API 15, which are embodied with two different programming languages C and Java. Such two API sets provide identical functions although they are defined with different programming languages C and Java. Therefore, an application developer may use preferable one of C and Java to develop the applications. Functions provided to the basic API 15 are 1) a kernel function related to memory management, program management and system information, 2) a graphic function for drawing various pictures on a screen or a frame buffer and processing a graphic event or text input, 3) a database function providing APIs that store, search or manage data in a unit of a record, 4) a file system function for using files and directories in a hierarchical direction file system, 5) a network function providing APIs for PPP connection, TCP/IP socket connection and HTTP connection, 6) a data processing function providing APIs for processing sound and moving picture, 7) a serial function providing APIs for controlling and using a serial port, 8) a phone function for processing Calls and transmitting/receiving short message services (SMS), 9) a Misc function for controlling light emitting diode (LED) or backlight, and 10) an UI function providing basic components to form a user interface (UI).

Meanwhile, an OEM API 14 is an API for providing supplementary functions according to a manufacturer or a service provider, and an application manager 16 is a program that manages application programs. That is, the application manger 16 downloads, installs and deletes an application program 17.

FIG. 2 is a diagram illustrating a DMB/mobile communication network linkage platform for interactive service in accordance with a preferred embodiment of the present invention. That is, FIG. 2 shows an expended platform to provide an interactive data broadcasting service interacting with a terrestrial digital multimedia broadcasting (DMB) and a mobile communication network.

In order to provide the DMB/mobile communication network linkage platform for the interactive service based on the conventional WIPI shown in FIG. 1, following functions are required. That is, the DMB/mobile communication network linkage platform for the interactive service requires following functions.

At first, a function for controlling a DMB is required. The function for controlling the DMB includes 1) a function for changing a DMB channel, 2) a function for setting a DMB sub-channel, 3) a function for controlling a location and a size of a DMB video on a screen, 4) a function for controlling a volume of DMB audio, and 5) a function for processing data transmitted through a DMB network.

Secondly, a function for providing interactive broadcasting service is required. The interactive broadcasting service function includes 1) a function for processing data transmitted or received through an interactive network, and 2) a function for transmitting a request to an interactive server.

As shown in FIG. 2, the DMB/mobile communication network linkage platform further includes a DMB basic S/W 21, a DMB HAL engine 22, a DMB runtime engine 23, and a DMB API 24 as extended functions for providing DMB interactive service.

The DMB basic software (S/W) 21 provides a DMB basic function corresponding to the handset basic S/W 11 of the WIPI platform. That is, the DMB basic S/W 21 provides driver functions related to the DMB.

The DMB HAL engine 22 is a lower abstract layer to provide a control function for a terrestrial DMB and a function for an interactive communication, which is corresponding to the HAL 12 of the WIPI. A terminal is controlled through such an abstract layer by the platform on the abstract layer. Since details of control can be embodied under the abstract layer, the platform above the abstract layer can reduce dependency of hardware according to the various terminals by the DMB HAL engine 22 which is the abstract layer. The DMB HAL engine 22 is generally divided into a DMB A/V HAL and a DMB data HAL because the broadcasting contents include video broadcasting streams and data broadcasting streams.

The DMB API 24 is a basic API for DMB similar to the basic API 15 of the conventional WIPI platform, and provides following functions. That is, the DMB API 24 provides 1) a screen and volume controlling function for controlling a location and a size of a screen and controlling a volume of audio, 2) a channel and sub-channel changing function for changing receiving frequency, i.e., ensemble frequency, of a receiver and controlling to receive or not to receive data sub-channel within the ensemble frequency, 3) a function for requesting a return channel server to transmit a file based on a predetermined protocol and for properly responding according to information transmitted from the return channel server by transmitting necessary information when the file transmission request is transmitted, and 4) a function for providing a DMB event transferring structure according to various DMB related events such as file arrival and success of broadcasting receiving, and registering a listener to receive a notice of event generation for the application to perform corresponding operations according to the generated event.

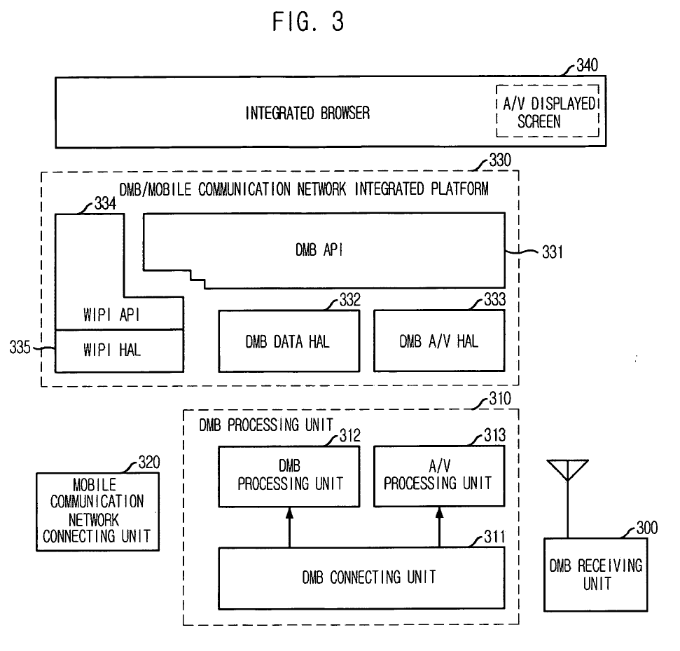

FIG. 3 is a diagram of a DMB/mobile communication network integrated receiving terminal employing a DMB/mobile communication network linkage platform for interactive service in accordance with a preferred embodiment of the present invention.

Referring to FIG. 3, the DMB/mobile communication network integrated receiving terminal includes a DMB receiving unit 300, a DMB processing unit 310, a mobile communication network connecting unit 320, a DMB/mobile communication network linkage platform 330 and an integrated browser 340. The DMB receiving unit 300 and the DMB processing unit 310 may be defined as a DMB receiving/processing unit.

The DMB receiving unit 300 receives broadcasting stream transmitted through a broadcasting network and transfers the received broadcasting stream to the DMB processing unit 310.

The DMB processing unit 310 determines a type of the received broadcasting stream. If the type of the received broadcasting stream is an audio/video stream, the DMB processing unit 310 decodes the received broadcasting stream and transfers the decoded broadcasting stream to the integrated browser 340. If the type of the received broadcasting stream is a data broadcasting stream, the DMB processing unit 310 stores the received broadcasting stream as a file and reports completion of data transmission to the DMB/mobile communication network linkage platform 330. Also, the DMB processing unit 310 request interactive data to the return server through the mobile communication network connecting unit 320 in response to an interactive data request of the DMB/mobile communication network linkage platform 330.

As shown in FIG. 3, the DMB processing unit 310 includes a DMB connecting unit 311, an audio/video (A/V) processing unit 313, and a data processing unit 312. The DMB connecting unit 311 receives a broadcasting stream, which is received at the DMB receiving unit 300, and determines the type of the received broadcasting stream. According to the determination, the DMB connecting unit 311 transfers the audio/video stream to the A/V processing unit 313 and transfers the data broadcasting stream to the data processing unit 312. The data processing unit 312 stores the data broadcasting stream from the DMB connecting unit 311 or interactive data transmitted from the return server which is received through the mobile communication connecting unit 320 as a file, and reports completion of data transmission to the DMB/mobile communication network linkage platform 330. Also, the data processing unit 312 requests interactive data to the return server through the mobile communication network connection unit 320 in response to the interactive data request of the DMB/mobile communication linkage platform 330. The A/V processing unit 313 decodes the A/V stream from the DMB connecting unit 311 and transfers the decoded A/V stream to the integrated browser 340.

The mobile communication connecting unit 320 accesses the return server through a mobile communication network. That is, the DMB/mobile communication network integrated terminal accesses the return server through the mobile communication network connecting unit 320.

The DMB/mobile communication network linkage platform 330 includes a DMB API module 331, a DMB data HAL 332, a DMB A/V HAL 333, an API 334 and a HAL 335. The API 334 and the HAL 335 are identical to those of the conventional WIPI. Since functions thereof were described with reference to FIG. 2, detailed descriptions thereof are omitted. In order to provide the interactive data broadcasting service, the DMB/mobile communication linkage platform 330 creates events according to the report of data transmission completion from the DMB processing unit 320 and transfers the created events to the integrated browser 340. Also, the DMB/ mobile communication linkage platform 330 receives a user's request of interactive data from the integrated browser 340, and orders the DMB processing unit 310 to request the interactive data to the return server.

The integrated browser 340 analyses data files stored in the DMB processing unit 310 when the integrated browser 340 receives the event from the DMB/mobile communication network linkage platform 330, and outputs the result of the analysis or outputs the decoded A/V stream transferred from the DMB processing unit 310. Also, the integrated browser 340 receives the request of the interactive data from the user and transfers the user's request of the interactive data to the DMB/mobile communication network linkage platform 330.

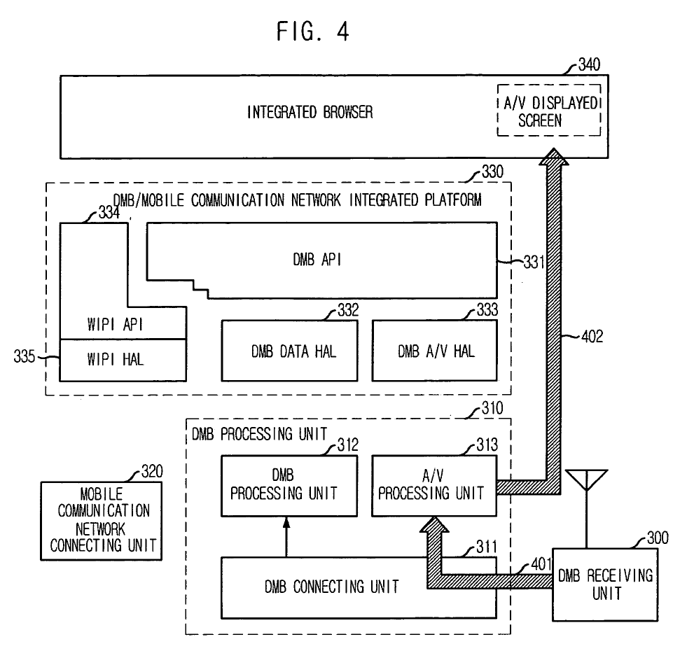

Hereinafter, operations of the DMB/mobile communication network integrated receiving terminal will be described in detail with reference to FIGS. 4, 5 and 6 based on flow of interactive data through a broadcasting network and a mobile communication network.

FIG. 4 is a diagram for describing a method of receiving and processing an A/V stream of a video broadcasting transmitted through a terrestrial DMB network in accordance with a preferred embodiment of the present invention.

Referring to FIG. 4, an A/V stream transmitted through a terrestrial DMB network is transmitted to the A/V processing unit 313 through the DMB receiving unit 300 and the DMB connecting unit 320 at step 401.

The A/V processing unit 313 decodes the A/V stream and transfers the decoded A/V data to the integrated browser 340 at step 402.

The integrated browser 340 outputs the decoded A/V data at a predetermined region of a screen 341 using related APIs in the DMB APIs.

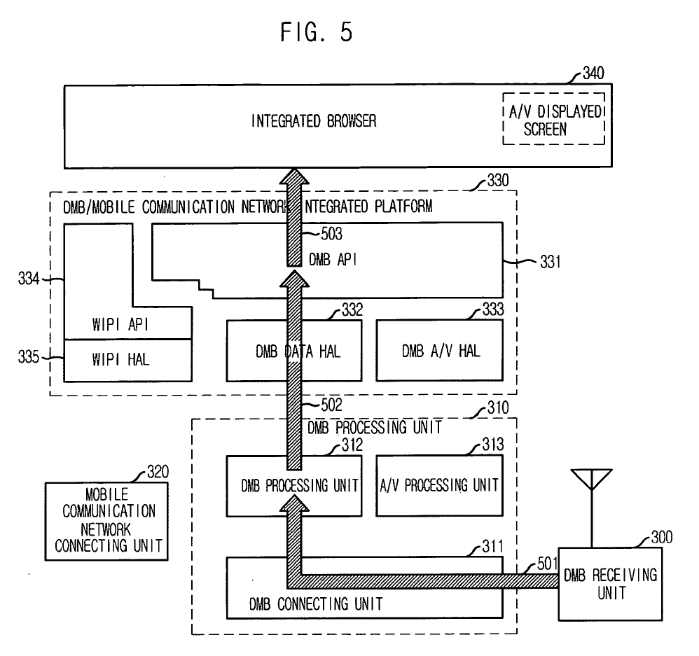

FIG. 5 is a diagram for describing a method of receiving and processing a data broadcasting stream transmitted through a terrestrial DMB network in accordance with a preferred embodiment of the present invention. That is, FIG. 5 shows one direction flow of data broadcasting stream.

The data broadcasting stream transmitted through the terrestrial DMB network is transmitted to the data processing unit 312 through the DMB receiving unit 300 and the DMB connecting unit 320 at step 501.

The data processing unit 312 stored the transmitted data stream as a file and notices the completion of data transmission to the DMB/mobile communication linkage platform 330 at step 502.

In response to the notice, the DMB/mobile communication linkage platform 330 creates events at step 503.

After the integrated browser 340 receives the created events, the integrated browser 340 analyzes information of the data file stored in the data processing unit 312 and displays the results on a screen using an I/O API among the DMB APIs.

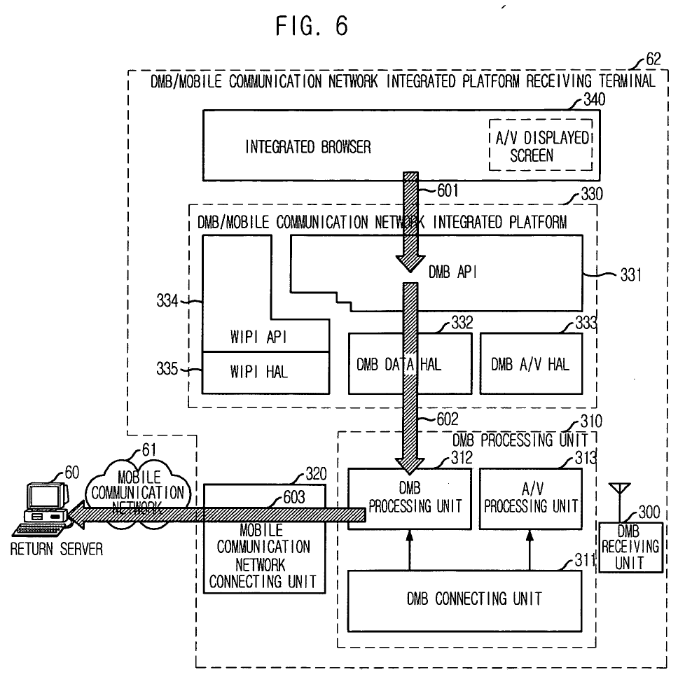

FIGS. 6 to 8 shows flow of interactive data through a mobile communication network in accordance with a preferred embodiment of the present invention.

As shown in FIGS. 6 to 8, the interactive data broadcasting service is achieved as follows.

At first step, a request of data transmission is transmitted to the return server 60, i.e., return channel server, in response to a user's request, as shown in FIG. 6.

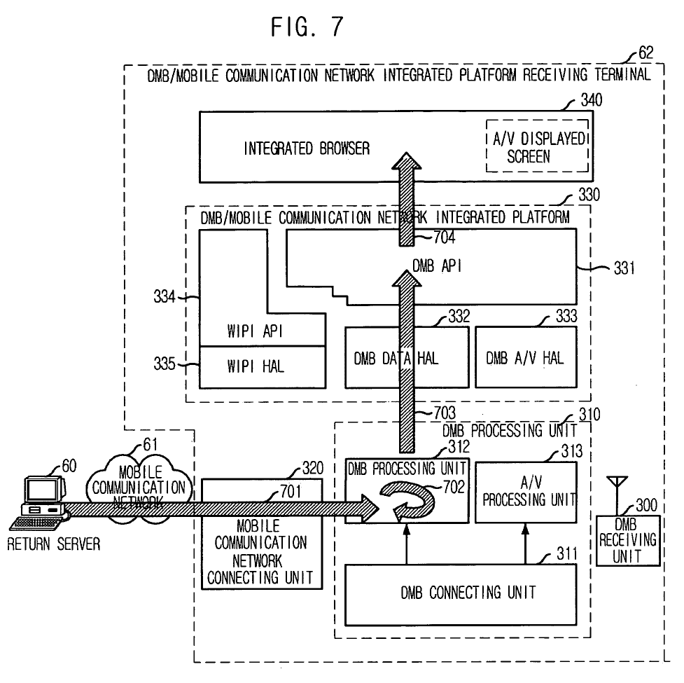

At second step, the return server 60 transmits related data through the mobile communication network such as a CDMA network when it is required, as shown in FIG. 7.

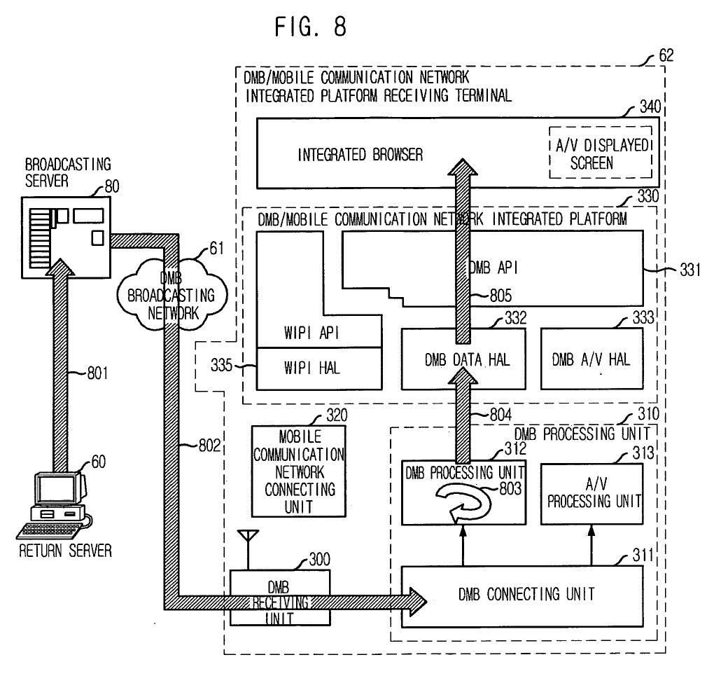

At third step, if it is required to change broadcasting data according to the data transmission request, the return server 60 notices the change of the broadcasting data to a broadcasting server 80 as shown in FIG. 8. The broadcasting server 80 instantly transmits the changed broadcasting data through the broadcasting network when broadcasting data is required to be changed. Meanwhile, if it is not a time to broadcast the changed broadcasting data although the request of changing data is noticed to the broadcasting server, the state of the broadcasting data is changed and then the changed broadcasting data is transmitted through the broadcasting network later according to a predetermined time of the changed broadcasting data.

At fourth step, the DMB/mobile communication network integrated terminal displays the A/V data stream or the data stream, stores data, or performs program based on data transmitted as the result of the second step or the third step. And then, the first to fourth steps are repeatedly performed.

FIG. 6 is a diagram showing a method of transmitting a request of transmitting interactive data from the DMB/mobile communication network integrated receiving terminal 62 to the return server 60 in accordance with a preferred embodiment of the present invention.

As shown in FIG. 6, the integrated browser 340 request transmission of interactive data to the DMB/mobile communication linkage platform 330 according to the user's request at step 601.

The DMB/mobile communication network linkage platform 330 orders the data processing unit 310 to request the interactive data to the return server 60 at step 602.

In response to the order, the data processing unit 310 opens a CDMA connection to the return server 60 through the mobile communication network connecting unit 320 and transmits the request of data transmission to the return server 60 at step 603. In the step 603, if the data processing unit 310 is already connected to the return server 60, the existing connection is used to transmit the request to the return server 60.

FIG. 7 is a diagram showing a method of receiving and processing interactive data transmitted from the return server to the DMB/mobile communication network integrated receiving terminal through a mobile communication network in accordance with a preferred embodiment of the present invention.

As shown in FIG. 7 the return server 60 receives the request of transmitting the interactive data through the mobile communication network 61, determines whether there is related data to be transmitted to the DMB/mobile communication network integrated receiving terminal 62 and transmits the related data to the DMB/mobile communication network integrated receiving terminal 62 through the mobile communication network at step 701.

When the DMB/mobile communication network integrated receiving terminal 62 receives the interactive data through the mobile communication network connecting unit 320, the data processing unit 312 stores the received data as a file at step 702.

After storing, the data processing unit 312 notices the completion of the data transmission to the DMB/mobile communication network linkage platform 330 at step 703.

The DMB/mobile communication network linkage platform 330 creates an event to notice receiving of the data and transmits the created event to the integrated browser 340 at step 704.

When the integrated browser 340 receives the created event, the integrated browser 340 analyzes the stored data file in the data processing unit 312 and displays it on the screen using the file I/O API.

FIG. 8 is a diagram showing a method of transferring data when data broadcasting service is changed by an interactive service through a terrestrial DMB network in accordance with a preferred embodiment of the present invention.

As shown in FIG. 8, when the return server 60, i.e., return channel server, receives the request of data transmission and is required to change corresponding data accordingly, the return server 60 reports details of the change to the broadcasting server 80 at step 801.

The broadcasting server 80 changes the data according to the reports from the return server 60 and broadcasts corresponding files of the changed data through a skyway broadcasting network 81 at step 802.

When the DMB/mobile communication network integrated receiving terminal 62 receives data through the broadcasting receiving unit 300 at step 802, the data processing unit 312 stores the received data as a file at step 803.

The data processing unit 312 generates an event noticing the completion of data transmission after storing the data and transfers the event to the DMB/mobile communication network linkage platform 330 at step 804.

After the integrated browser 340 receives the event, the integrated browser 340 analyzes the information of the files and displays it on a screen using the file I/O API.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

As described above, a user can exchange supplementary information through the mobile communication network while properly displaying the broadcasting data transmitted through the terrestrial DMB on a screen according to the present invention. That is, the interactive data broadcasting service is provided using the mobile communication network according to the present invention.

Therefore, the interactive data broadcasting service interacting with the mobile communication network is provided by expanding the WIPI to have DMB related functions according to the present invention.

The present application contains subject matter related to Korean patent application No. 2005-42200, filed in the Korean Intellectual Property Office on May 19, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims. What is claimed is:

1. A digital multimedia broadcasting (DMB)/mobile communication network linkage platform having a handset basic software module, a handset adaptation layer (HAL) module, a runtime engine and a basic application program interface (API) module based on a wireless Internet standard platform for interactive service, the DMB/mobile communication linkage platform comprising:
a DMB basic software module for providing DMB basic functions corresponding to a handset basic software of the wireless internet standard platform;
a DMB HAL engine as a lower abstract layer for providing a function of controlling DMB and a function for interactive communication;
a DMB runtime engine for providing an environment for DMB APIs; and
a DMB API module for providing DMB basic APIs corresponding to basic APIs of the wireless Internet standard platform.

2. The DMB/mobile communication network linkage platform as recited in claim 1, wherein the DMB basic functions in the DMB basic software module includes a function related to DMB driver.

3. The DMB/mobile communication network linkage platform as recited in claim 1, wherein the DMB HAL engine includes a DMB audio/video HAL for a moving picture broadcasting and DMB data HAL for data broadcasting, and provides environment for the DMB A/V HAL and the DMB data HAL.

4. The DMB/mobile communication network linkage platform as recited in claim 1, wherein the DMB API module includes an application program interface (API) for providing a screen/volume controlling function, a channel and sub-channel changing function, a function for transmitting a request to a return server, or a function for creating DMB related event and noticing the creation of DMB related event.

5. The DMB/mobile communication network linkage platform as recited in claim 1, wherein the wireless Internet standard platform is a wireless Internet platform for interoperability (WIPI).

6. A digital multimedia broadcasting (DMB)/mobile communication network integrated receiving terminal for interactive service, comprising:
a DMB receiving means for receiving broadcasting stream transmitted through a broadcasting network;
a DMB processing means for determining a type of the broadcasting stream, decoding an audio/video stream and transferring the decoded audio/video stream, reporting completion of data transmission after storing data broadcasting stream, or reporting completion of data transmission after storing interactive data received as a response of interactive data request to a return server;
a mobile communication network connecting means for connecting the return server through a mobile communication network;
a DMB/mobile communication network linkage platform for generating an event when the completion of data transmission is received from the DMB processing means, and ordering the DMB processing means to request the interactive data to a return server according to a user's request of the interactive data transferred from the integrated browsing means; and
an integrated browsing means for receiving the decoded audio/video stream from the DMB processing means, processing data file stored in the DMB processing means and outputting the processed data file according to receiving of the generated event, or processing and outputting the decoded audio/video stream transferred from the DMB processing means, and transferring the user's request of the interactive data to the DMB/mobile communication network platform.

7. The DMB/mobile communication network integrated receiving terminal as recited in claim 6, wherein the DMB processing means includes:
a DMB connecting means for receiving a received broadcasting stream from the DMB receiving means, determining a type of the received broadcasting stream, and separately transferring an audio/video (A/V) stream and a data broadcasting stream;
a data processing means for receiving the data broadcasting stream from the DMB connecting means, storing the received data broadcasting stream and interactive data of a return server received through the mobile communication connecting means as a file, and reporting the completion of data transmission to the DMB/mobile communication network linkage platform, or requesting interactive data to the return server through the mobile communication connecting means in response to the request order of the DMB/mobile communication network linkage platform; and
an audio/video processing means for receiving the A/V stream from the DMB connecting means, decoding the A/V stream from the DMB connecting means and transferring the decoded audio/video stream to the integrated browsing means.

8. The DMB/mobile communication network integrated receiving terminal as recited in claim 7, wherein the DMB/mobile communication network linkage platform is the DMB/mobile communication network linkage platform as recited in one of claims 1 to 5.

9. The DMB/mobile communication network integrated receiving terminal as recited in claim 8, wherein the integrated browsing means processes and outputs data using DMB API.

10. The DMB/mobile communication network integrated receiving terminal as recited in claim 8, wherein the return server receives the request of the interactive data transmitted through the mobile communication network and transmits related data to the mobile communication network connecting means, and if data is required to be changed, the return server notices corresponding information about changed data to the broadcasting server.

11. A method of receiving integrated data for interactive service in a digital multimedia broadcasting (DMB)/mobile communication network integrated receiving terminal employing a DMB/mobile communication network linkage platform expanded based on a wireless Internet standard platform, the method comprising the steps of:
receiving broadcasting stream transmitted through a broadcasting network and determining a type of the received broadcasting stream;
transferring the broadcasting stream to an integrated browser when the determined type of the broadcasting stream is an audio/video stream;
storing the broadcasting steam when the determined type of the broadcasting stream is a data broadcasting stream, and reporting a first data transmitting completion to the DMB/mobile communication network linkage platform;
generating an event according to the reporting of the first data transmitting completion from the DMB/mobile communication network linkage platform and noticing the creation of event to the integrated browser; and
at the integrated browser, processing and outputting the data or the decided audio/video stream by recognizing the data transmitting completion by the event.

12. The method as recited in claim 11, further comprising:
at the integrated browser, receiving a request of interactive data from a user and transferring the request to the DMB/mobile communication network linkage platform;
at the DMB/mobile communication network linkage platform, ordering to request an interactive data to a return server according to the request of the interactive data;
requesting the interactive data to the return server according to the order of the DMB/mobile communication network linkage platform; and
receiving and storing the interactive data transmitted through a mobile communication network through the return server, and reporting second data transmitting completion to the DMB/mobile communication network linkage platform.

13. The method as recited in claim 12, wherein in the storing of data in the steps of reporting the first data transmitting completion and the second data transmitting completion, the data broadcasting stream or the interactive data are stored as a file.

14. The method as recited in claim 13, wherein in the step of processing and outputting, the data or the decoded audio/video stream are processed and outputted using a DMB API.
